(19) United States
(12) Patent Application Publication
(10) Pub. No.: US 2014/0120495 A1
(43) Pub. Date: May 1, 2014

(54) DEPTH STOP FOR SURGICAL INSTRUMENTS

(71) Applicant: BIOHORIZONS IMPLANT SYSTEMS, INC., Birmingham, AL (US)

(72) Inventors: Larry ZEIGLER, JR., Birmingham, AL (US); Fred J. MOLZ, Birmingham, AL (US)

(73) Assignee: BIOHORIZONS IMPLANT SYSTEMS, INC., Birmingham, AL (US)

(21) Appl. No.: 14/059,928

(22) Filed: Oct. 22, 2013

Related U.S. Application Data
(60) Provisional application No. 61/718,244, filed on Oct. 25, 2012.

(51) Int. Cl. A61C 1/08; A61C 3/02; A61C 8/00

(52) U.S. Cl. CPC A61C 1/084; A61C 8/0089; A61C 3/02
USPC 433/75; 433/173

(57) ABSTRACT

A surgical tool or instrument having a plurality of depth stop positions, settings or locations, allowing for depth adjustment or a limitation of the allowable extension of a working tool coupled to or used in combination with the instrument. In example forms, an appliance or mouthpiece provides a guide to retain the surgical instrument to a particular orientation, and a stop member coupled to the tool or instrument in at least one of the plurality of depth stop positions, settings or locations determines the extension of the working tool therein.

### CROSS-REFERENCE TO RELATED APPLICATION

This application claims the benefit of U.S. Provisional Patent Application Ser. No. 61/718,244 filed Oct. 25, 2012, the entirety of which is hereby incorporated by reference herein.

### TECHNICAL FIELD

The present invention relates generally to the field of surgical instruments, and more particularly to surgical instruments having one or more stops for providing customization or adjustability to the depth of penetration or extension of the same.

### BACKGROUND

Surgery is often specialized to accommodate a patient's particular anatomy, for example, wherein one or more aspects of surgical techniques to be performed are generally specific to the patient. As shown in FIGS. 1A-C, the pre-surgical procedure for providing dental implants commonly uses computerized software CS to obtain a three-dimensional scan of a patient's jaw or dental area. The three-dimensional scan is then used to form an appliance or patient-specific mouthpiece PSM used to assist the practitioner in carrying out the implant procedure (see FIG. 1A).

Generally, before constructing the mouthpiece to assist in the surgical procedure, guides or guidance features are placed or incorporated into the three-dimensional appliance as necessary to assist the surgeon when applying a working tool WT to the patient. Depending upon the specifics of the three-dimensional scan of the patient's anatomy, the allowable or proper depth of penetration of the drill or other working tool that is to extend within the guides can vary, quite commonly resulting in requiring the use of a plurality of working tools having a plurality of operative lengths (see FIG. 2A). The working tools are then placed within the predetermined guides (one at a time) and inserted therein until a depth stop DS bottoms out on the surgical guide or appliance SG. Thus, depending on the patient, a plurality of working tools can be required to provide the desired result, which can be seen as a drawback by requiring a plurality of surgical instruments to perform the surgery. Accordingly, improved systems, devices and methods for controlling the depth of operation or penetration of a surgical instrument are desirable.

It is to the provision of improved systems, devices and methods of controlling the depth of operation or penetration of a surgical instrument meeting these and other needs that the present invention is primarily directed.

### SUMMARY

In example embodiments, the present invention provides a tool or instrument having a plurality of depth stop positions, settings or locations, allowing for depth adjustment or a limitation of the allowable extension of a working tool coupled to or used in combination with the instrument. In example forms, an appliance or mouthpiece provides a guide to retain the surgical instrument to a particular orientation, and a stop member coupled to the tool or instrument in at least one of the plurality of depth stop positions, settings or locations determines the extension of the working tool therein.

In one aspect, the present invention relates to a surgical instrument including a plurality of locations for depth adjustment. The surgical instrument includes a generally elongate body portion defining a longitudinal axis extending from a first end to a second end. The first end provides a coupling for engagement with a drive mechanism and the second end provides a coupling for engagement with a working tool and/or implant. Further, the drive piece includes a plurality of depth stop positions or locations, for example, grooves and/or holes extending along the periphery and/or through the elongate body. Preferably, each of the plurality of depth stop locations is positioned at a desired axial position along the longitudinal axis corresponding to one of a plurality of depth settings. Preferably, a repositionable or removable stop member including a pin and/or ring is provided for coupling to at least one depth stop location of the elongate body. Preferably, the stop member provides adjustability to the position that the second end is permitted to extend through an appliance or guide to allow for the proper depth of the working tool or implant extending therein. Preferably, the stop member can be repositioned between the axial positions along the longitudinal axis.

Optionally, the stop member is disengaged from the surgical instrument when repositioning is desired. Optionally, the stop member can index between the plurality of depth stop locations while maintaining engagement with the surgical instrument.

In another aspect, the invention relates to a method for adjusting a depth stop used in connection with a surgical instrument. The method includes providing a surgical instrument having a plurality of engagement features provided at predetermined positions along a defined longitudinal axis; and providing a stop member having at least one feature for engagement with the plurality of engagement features provided on the surgical instrument. In example forms, the method further includes providing adjustment to the axial position of the stop member along the longitudinal axis of the surgical instrument.

Optionally, the stop member may provide for removably coupling between the plurality of engagement features, wherein the stop member is disengaged from the surgical instrument when repositioning is desired. The method may optionally also include that the stop member may provide for indexing between the plurality of depth stops, wherein the stop member can index therebetween while maintaining engagement with the surgical instrument.

In another aspect, the present invention relates to a guide for installing a stop member on a drive and/or drill piece. In example forms, the drive and/or drill piece includes a plurality of depth stop locations extending along a defined longitudinal axis, and the stop member includes a feature for engagement with the guide. The guide includes a base and a guide post. The guide post includes a first end and a second end generally opposite the first end. The first end engages the base and the second end extends generally transverse relative to the base. A stop ring engages with the guide post to provide for the desired axial positioning of the stop member when the feature is engaged with the guide post. The base further comprises a channel having an indentation for receiving a portion of the working end of the working tool to provide alignment of the desired depth stop location with the stop member having the feature engaged with the guide post.

In yet another aspect, the present invention relates to a drill having a plurality of depth stop locations. The drill piece includes a generally elongate body portion defining a longitudinal axis extending from a first end to a second end. The first end provides engagement with a drive mechanism and the second end provides a working tool (e.g., drill, cutting tool, etc.). Preferably, a plurality of depth stop locations having grooves and/or holes extend along the periphery and/or through the elongate body.

In another aspect, the present invention relates to a method of planning a surgery. In example forms, the method of planning a surgery includes providing a scan of a patient's surgical area; viewing a patients surgical area within a computerized software, the computerized software providing information regarding one or more instruments that may be used to perform the surgery, the instruments including surgical drills and/or drill pieces; and providing instructions to a practitioner regarding the tools required to perform the surgery, the instructions showing where at least one depth stop should be placed on the instruments to provide for the desirable implant placement.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of the invention are exemplary and explanatory of preferred embodiments of the invention, and are not restrictive of the invention, as claimed.

### BRIEF DESCRIPTION OF THE DRAWINGS

FIGS. 1A-C show an implant placement system for assisting a practitioner in performing a procedure on a patient.

FIG. 2A-B show instruments used in connection with the implant placement system shown in FIGS. 1A-C.

FIGS. 3A-D show a drive piece according to an example embodiment of the present invention.

FIGS. 4A-D show a plurality of views of a stop member for releasably engaging portions of the drive piece shown in FIGS. 3A-D.

FIGS. 5A-D show a drive piece according to another example embodiment of the present invention.

FIGS. 6A-H show a plurality of stop members for releasably engaging portions of the drive piece shown in FIGS. 5A-D.

FIG. 7 shows a perspective view of a drive piece having a stop member removably engaged therewith according to another example embodiment of the present invention, wherein portions are removed to show additional features thereof.

FIGS. 8A-F show a plurality of views of the drive piece of FIG. 7.

FIGS. 9A-C show a plurality of views of the stop member shown in FIG. 7.

FIGS. 10A-D show a drive piece according to another example embodiment of the present invention.

FIGS. 11A-D show a plurality of views of a stop member for releasably engaging portions of the drive piece shown in FIGS. 10A-D.

FIGS. 12A-D show a drive piece according to yet another example embodiment of the present invention, the drive piece providing removable engagement with the stop member shown in FIGS. 11A-D.

FIGS. 13A-D show a drill piece according to another example embodiment of the present invention, the drill piece having a plurality of depth stops for receiving the stop member of FIGS. 4A-D.

FIGS. 14A-D show a plurality of views of a guide for installing the stop member of FIGS. 4A-D with one of the plurality of depth stops as shown in FIGS. 13A-D, according to another example embodiment of the present invention.

FIGS. 15A-B show the guide of FIGS. 14A-D and the drill piece of FIGS. 13A-D subsequent to assembling the stop member thereon.

FIGS. 16A-D show a drill piece according to yet another example embodiment of the present invention, the drill piece having a plurality of depth stops for receiving the stop member of FIGS. 4A-D.

FIGS. 17A-D show a plurality of views of a guide for installing the stop member of FIGS. 4A-D with one of the plurality of depth stops as shown in FIGS. 16A-D according to another example embodiment of the present invention.

FIGS. 18A-B show the guide of FIGS. 17A-D and the drill piece of FIGS. 16A-D subsequent to assembling the stop member thereon.

FIG. 19 shows the drill piece of FIGS. 16A-D drilling within a bone according to another example embodiment of the present invention, wherein the stop member engaged with one of the plurality of drill stops contacts the bone, preventing further extension of the drill piece therein.

### DETAILED DESCRIPTION OF EXAMPLE EMBODIMENTS

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

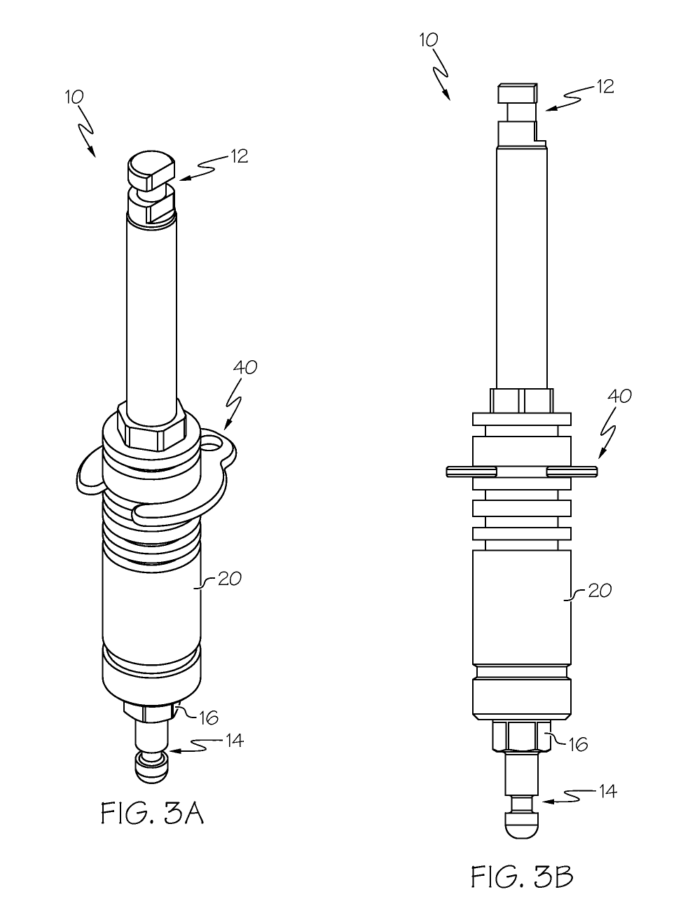

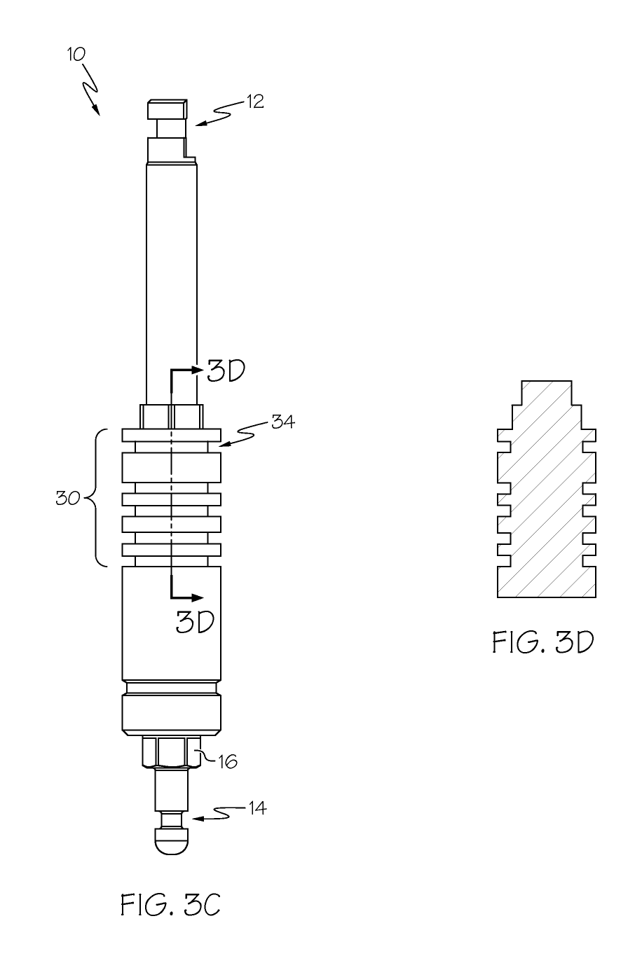

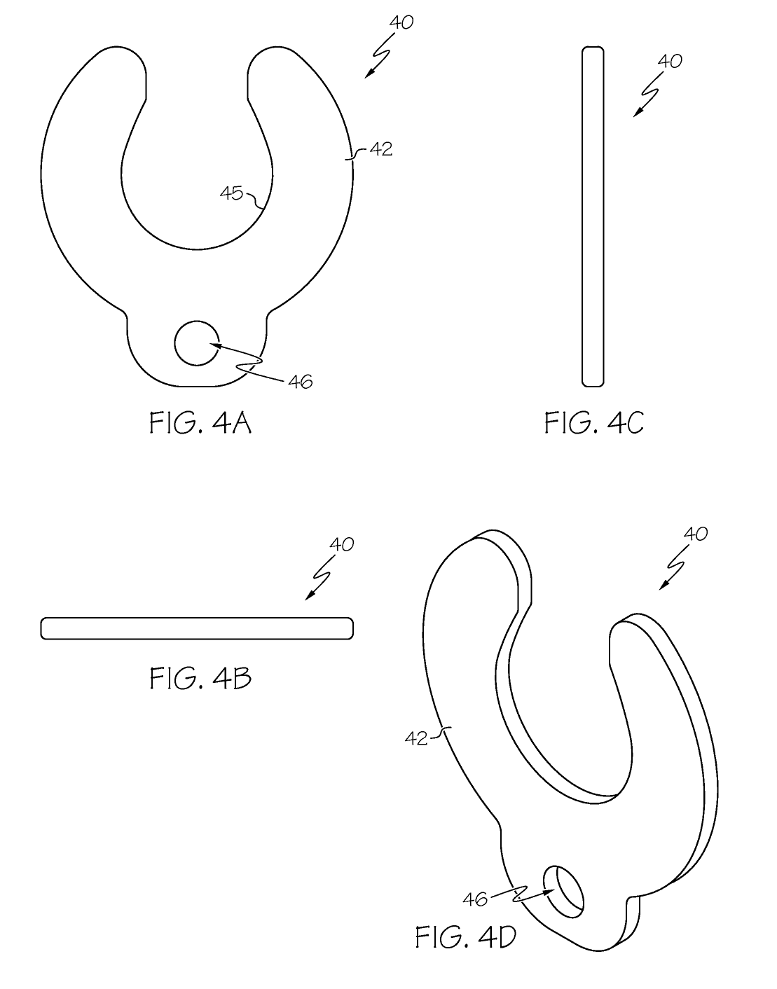

With reference now to the drawing figures, wherein like reference numbers represent corresponding parts throughout the several views, FIGS. 3A-12D show example embodiments of surgical instruments and/or drive pieces providing a plurality of depth stop positions according to example forms of the present invention. The depth stop positions include engagement features or retaining portions to receive one or more cooperative portions of a repositionable stop member that is generally configured for removable engagement therewith. The stop members are generally in the form of a pin and/or a clip that is used to limit or control the depth to which the drive piece or instrument can extend through or into a defined opening or substrate, for example, an appliance (retainer-like mouthpiece or guide).

In example forms, the axial position of the stop member relative to the working end of the drive piece determines the depth that the drive piece can extend through the defined opening or guide before contacting portions that define the same to restrict further extension therein. Optionally, the stop member can provide engagement with other elements or surfaces to restrict extension therein, which can be in the form of a bone or some other surface around or adjacent the area receiving the surgical instrument. As will be discussed below, in further embodiments, a drill can be provided with depth stops to provide for adjusting the allowable axial extension of the same within an opening formed from the drill cutting the bone or other element.

In some example forms, the guide is integral with the appliance so that the appliance will act as a guide. The guide is formed with the appliance to allow an operative portion of the working tool extending from a shank portion thereof to contact the same when performing a surgical procedure on a patient. As described above, the appliance is optionally produced using a software aided scanning procedure. The scanning procedure provides a patient with a patient-specific appliance (herein referred to as appliance), adapted for customized use in connection with that patient's personal anatomical structure, to perform the surgical procedure. Preferably, the appliance is sized, shaped, or otherwise configured to be supportive of the drive piece extending through the guide and working on the patient's jaw, for example at a desired orientation and/or to result in a desired depth of penetration.

The guide is generally sized to allow a portion of the drive piece 10 to extend therein while providing a contact area for the stop member to prevent the same from movement therein. Thus, depending on the location of the stop member, a single drive piece can provide a plurality of depths that can prevent further extension of the drive piece within the guide. In example forms, the portions of the stop member removably couple to the engagement features to provide positioning of the same at one or more axial positions along the shank portion, thus providing a plurality of depth-stops to removably mount the stop member therebetween. Optionally, the stop member can index throughout the engagement features along the longitudinal axis of the shank portion, for example, wherein actuation of the stop member provides the same with axial movement along the shank portion to engage another axial position or to allow for removal therefrom.

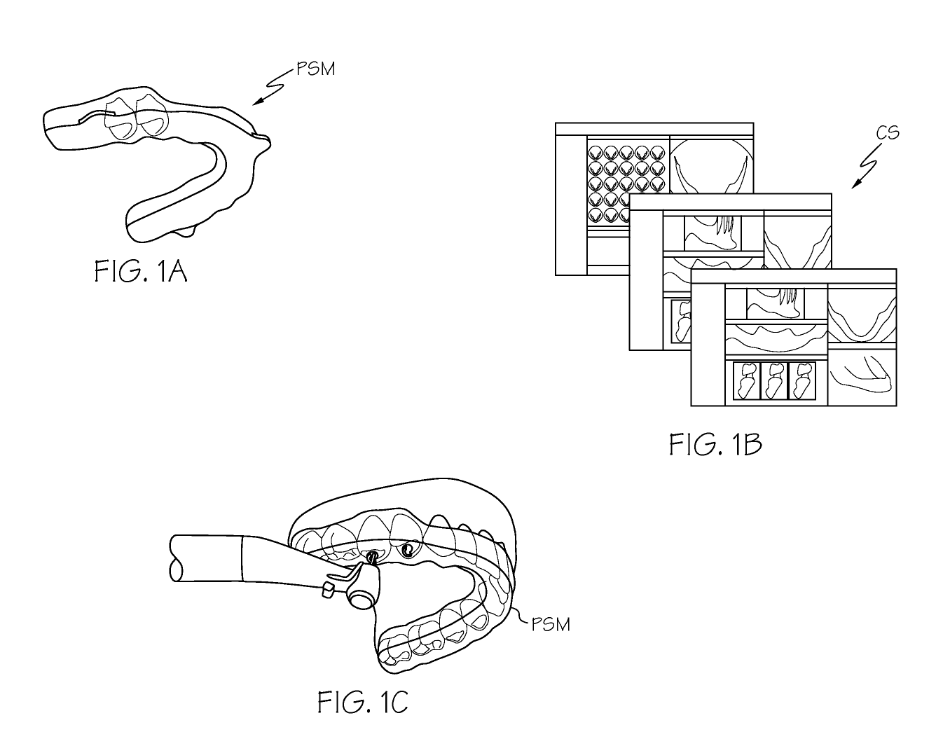

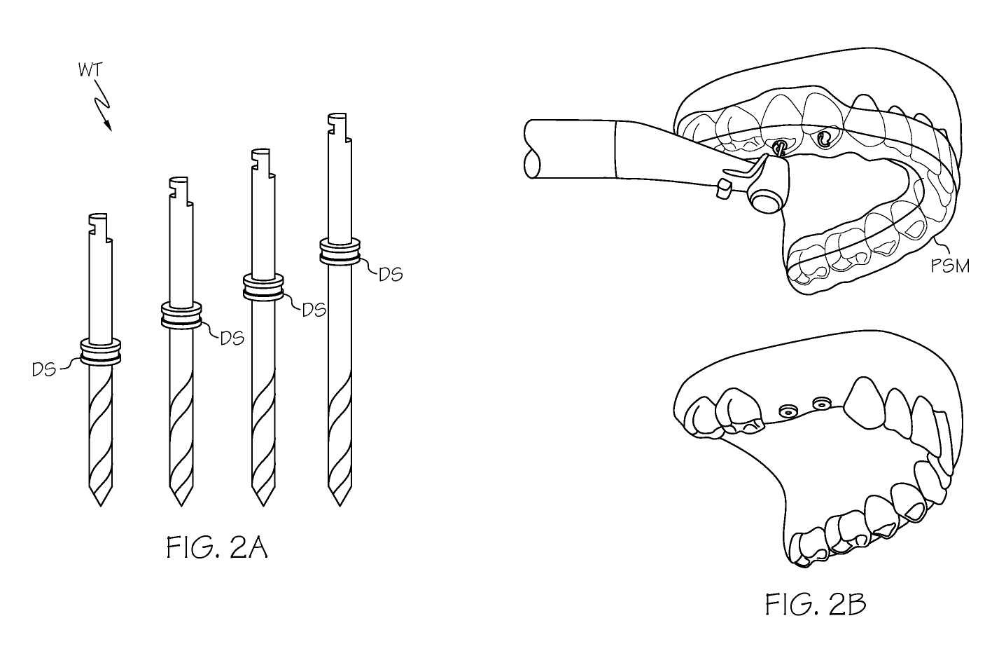

FIGS. 3A-D show a drive piece 10 according to an example form of the present invention. As depicted, the drive piece 10 is generally elongate and extends along a longitudinal axis from a first or connection end 12 to a second or working end 14. The first end 12 preferably comprises a drive coupling for connection with a dental hand piece or the like (see FIGS. 1-2), and the second end preferably comprises a tool coupling for connection with a working tool and/or an implant (unshown). A hex-like male feature 16 proximal the second end 14 provides for removably engaging an internal corresponding female portion of an implant (generally sized and shaped to receive the hex-like feature 16). A shank portion 20 generally extends along the longitudinal axis between the first end 12 and second end 14, and comprises the depth stops thereon. In example forms, the shank portion 20 is generally cylindrical and provides a plurality of depth stop engagement features or receivers 30 at axially spaced stop positions extending along the periphery thereof and/or therethrough (generally spaced along the longitudinal axis) such that a stop member or C-snap ring 40 can removably couple to a selected one of the plurality of axial stop positions along the same. As such, the stop member 40 provides engagement with the guide, surface or feature when driving the working tool or implant within the same.

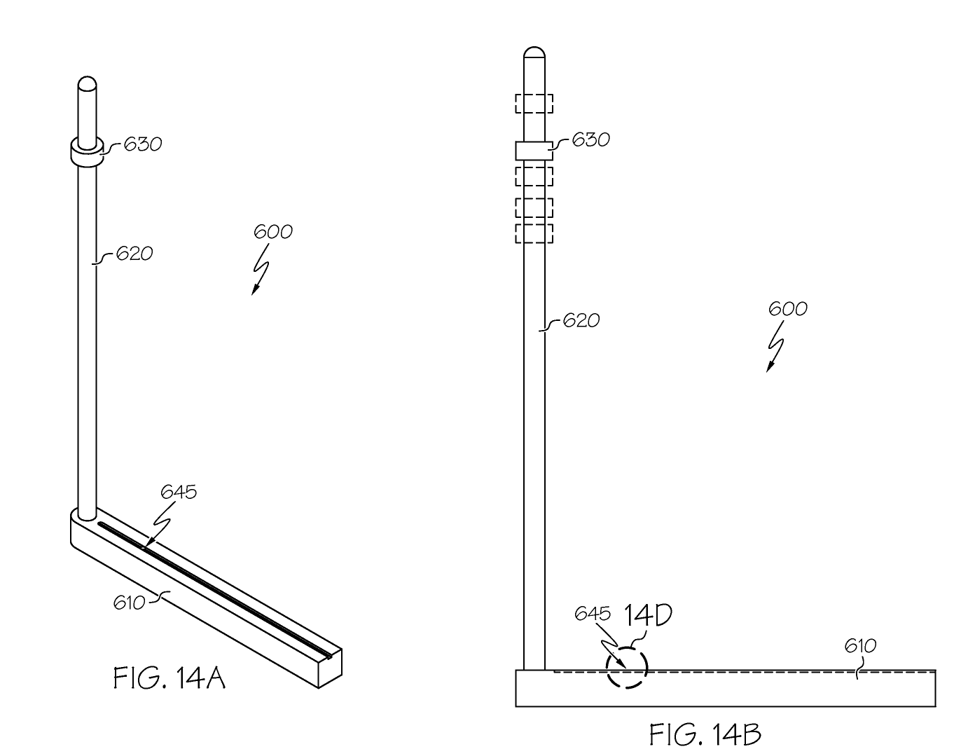

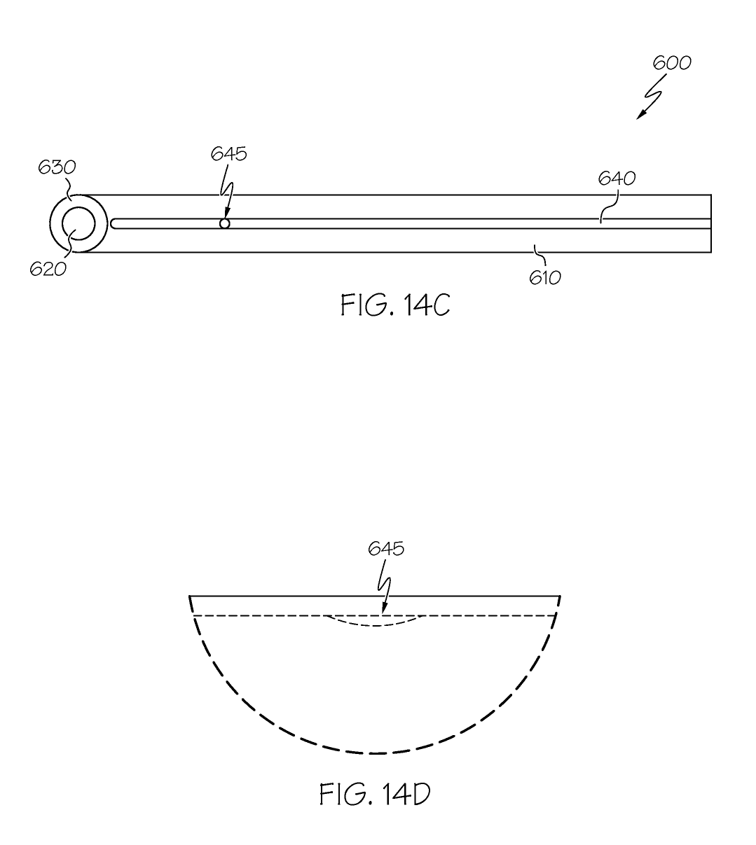

The engagement features 30 can be formed from a plurality of channels 34, holes and/or the like such that the stop member 40 can removably and repositionably couple thereto and/or be indexed therebetween to any selected position among the plurality of stop positions. For example, as depicted in FIG. 3A-B and 4A-D, the stop member 40 forms a C-shaped body 42 that is configured to flex to allow engagement with or during removal from the channels 34. In example forms, inner portions 45 of the C-shaped body are sized and shaped to accommodate engaging a portion of the engagement features 30. A removal feature or hole 46 is optionally provided on a portion of the stop member 40 to facilitate removal of the stop member from the receiver and/or for safety precautions. For example, a dental pick can be inserted within the hole 46 to remove the stop member 40 from the channel 34, and a string or floss (dental floss) can be attached to the stop member 40 to ensure it is not lost or potentially cause a choking hazard to the patient. Optionally, as will be discussed below, a guidance apparatus or jig 600, 800 (see FIGS. 14A-D, 17A-D) can be provided to assist the installation and removal of the stop member 40 from the plurality of channels 35.

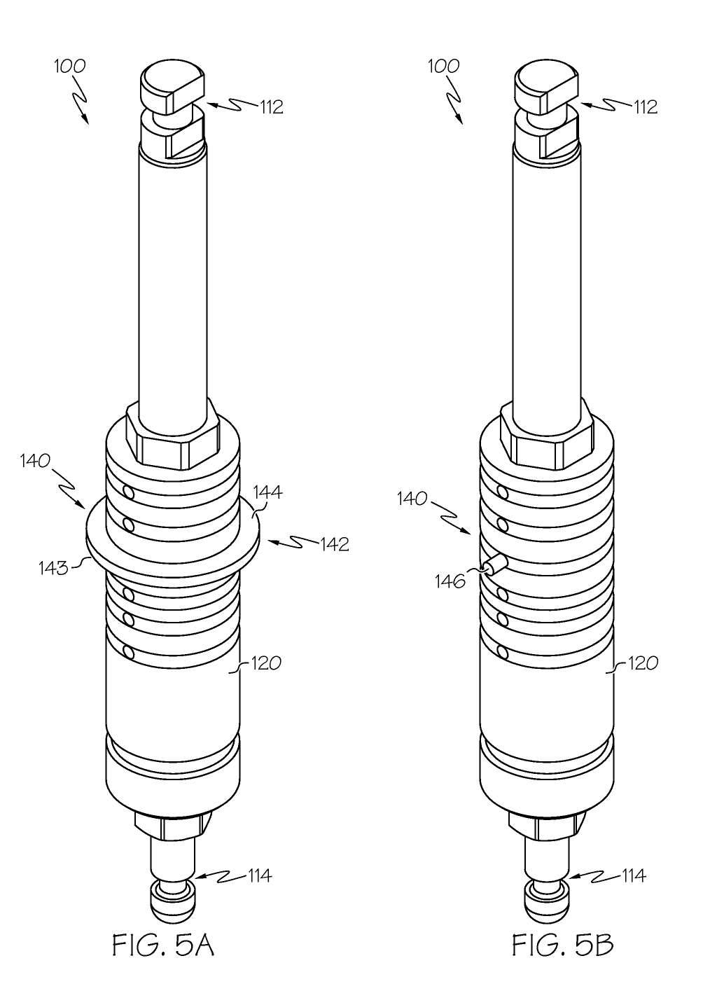

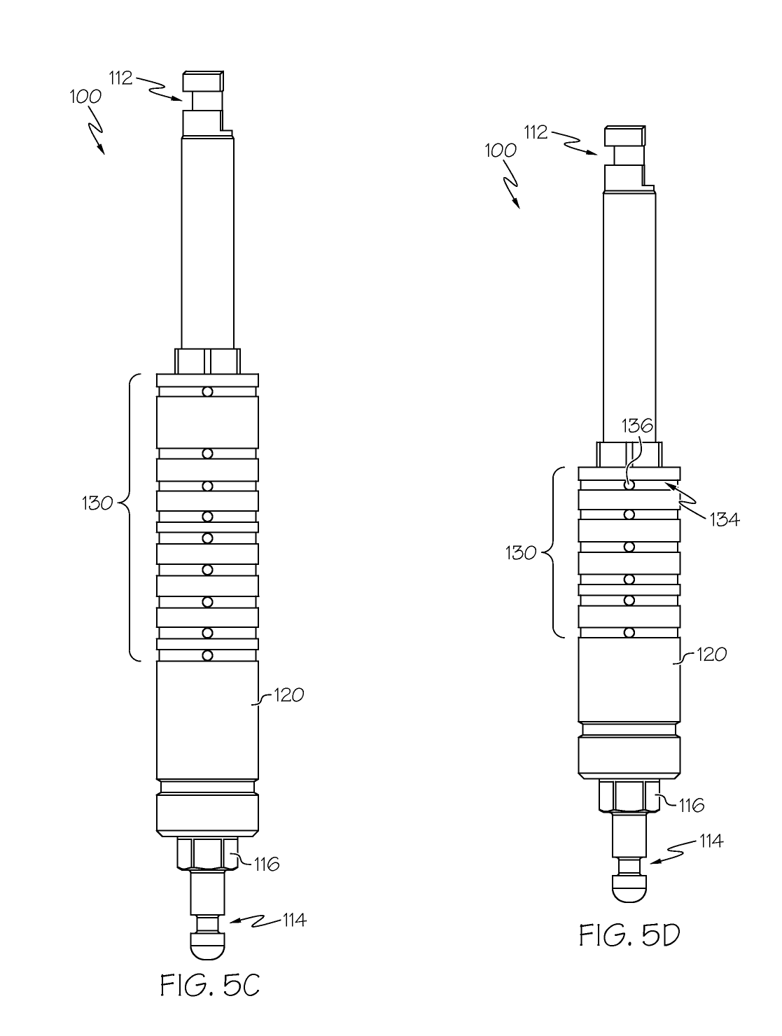

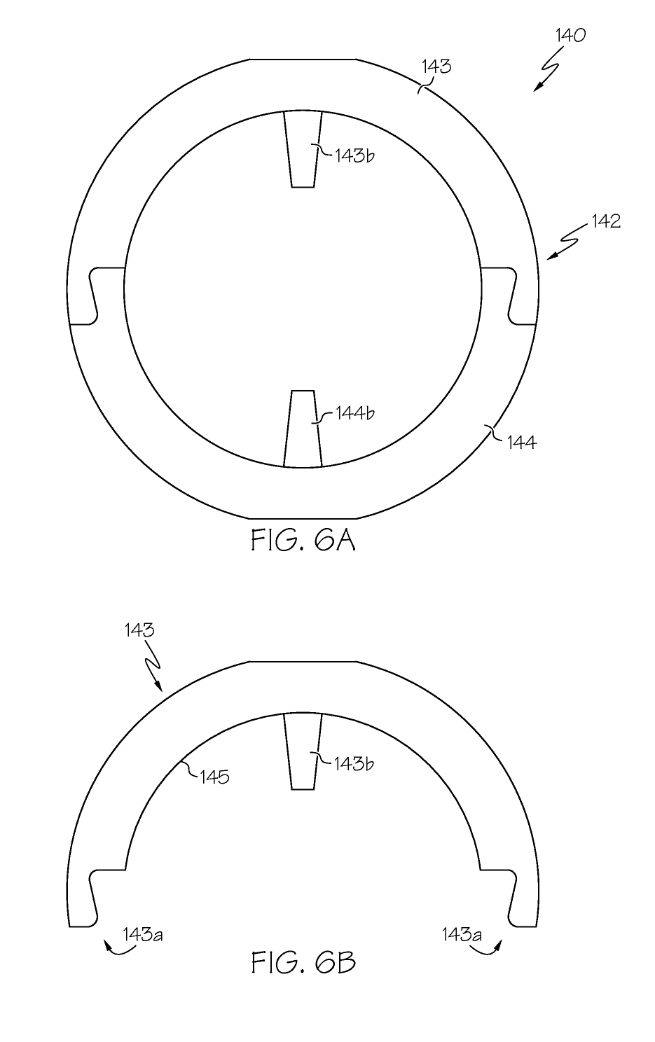

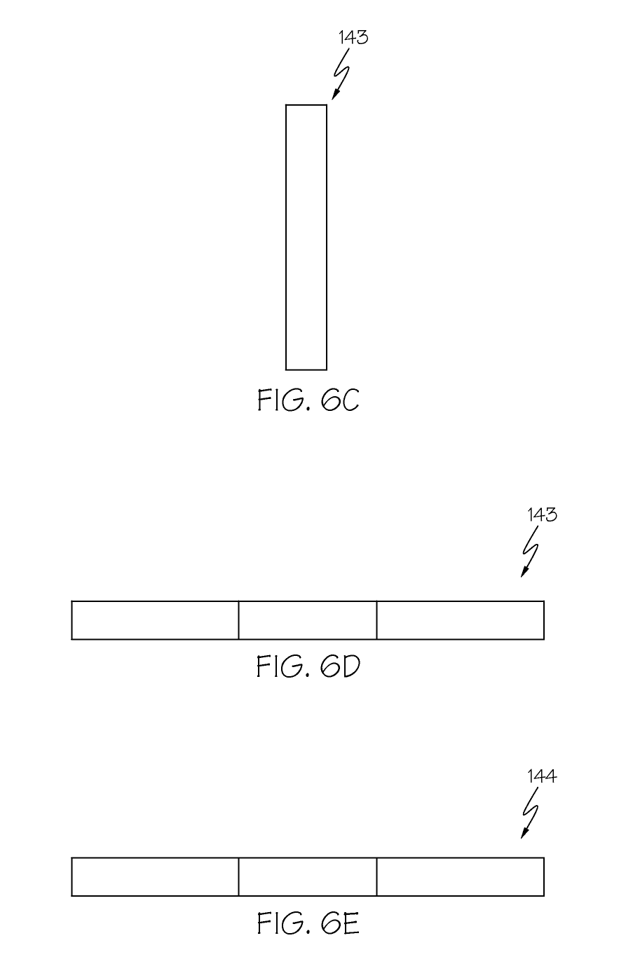

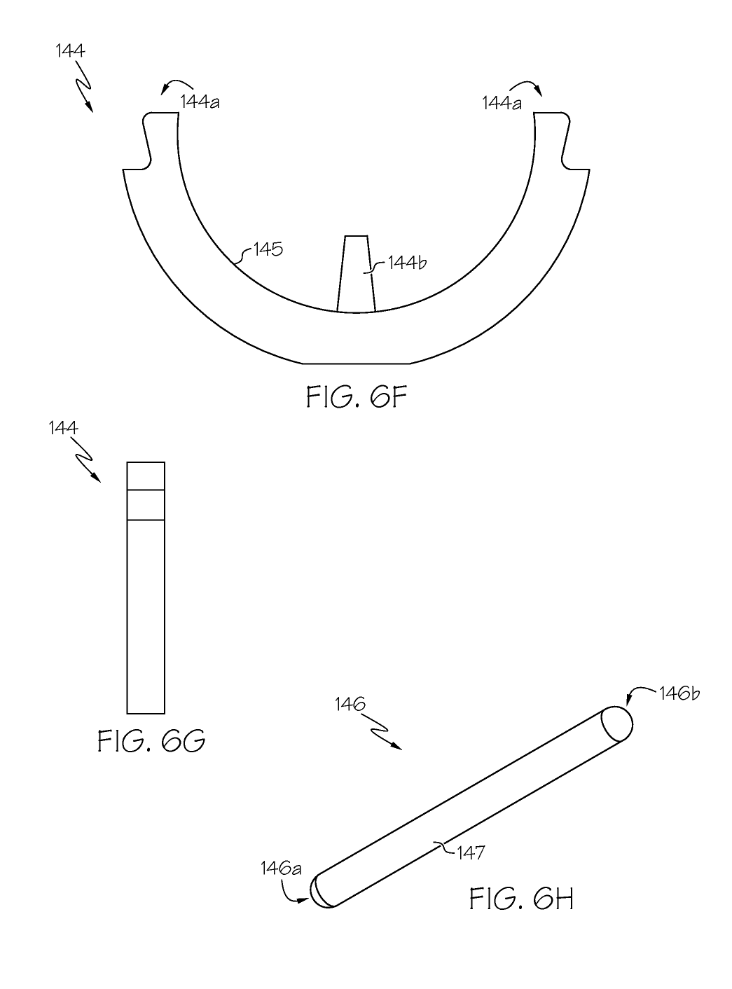

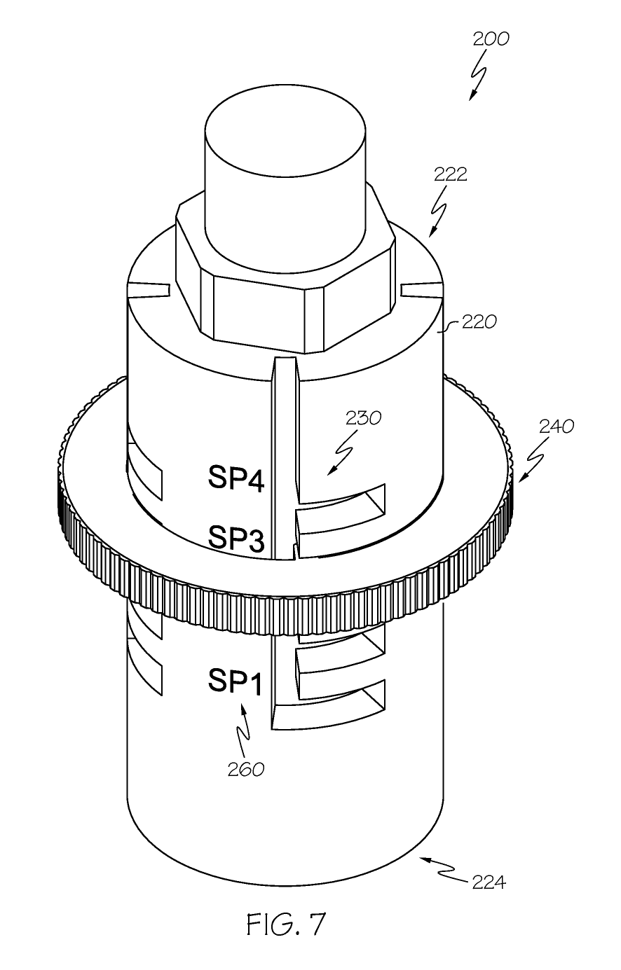

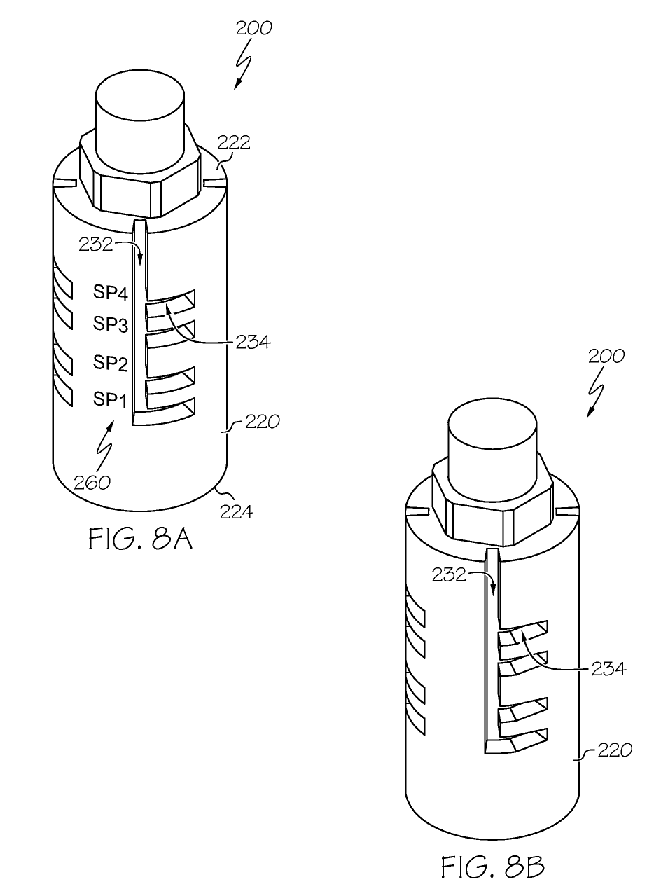

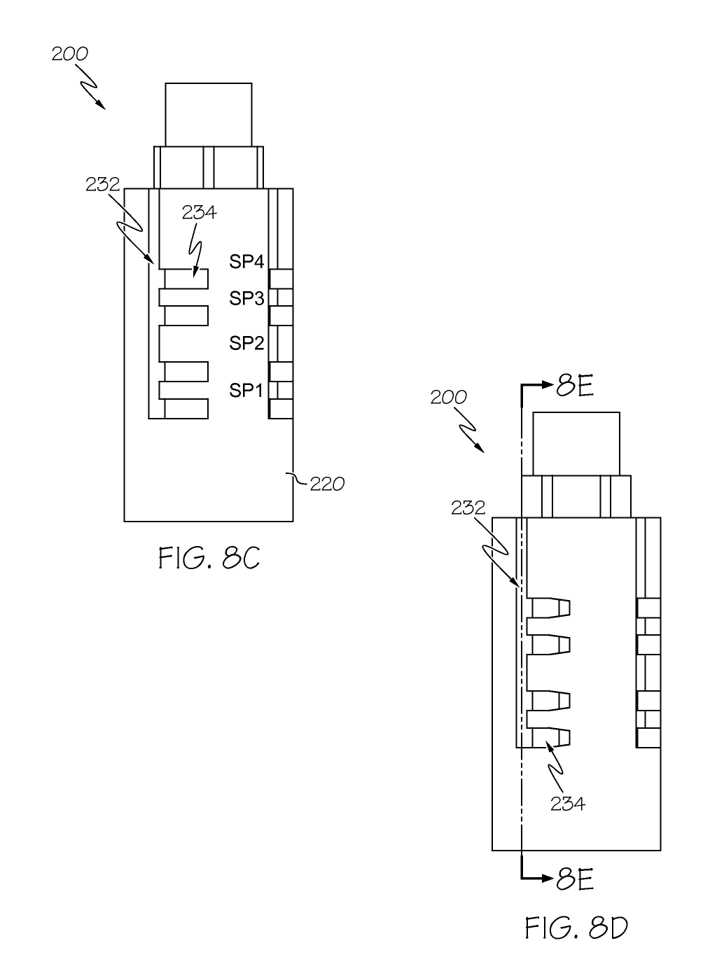

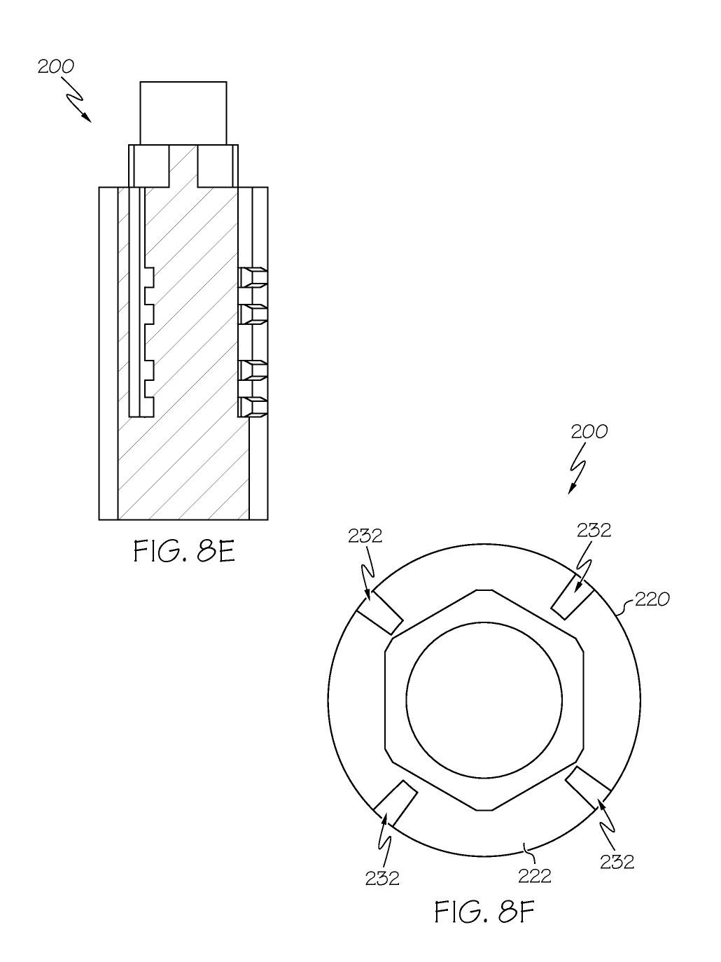

FIG. 5 shows a drive piece 100 according to another example form of the present invention. As depicted, the drive piece 100 is generally similar in shape and form as that shown in FIGS. 3A-D, and further comprises a repositionable stop member 140 in the form of an interengaging clip 142 or a pin 146. As depicted in example forms shown in FIGS. 6A-G, the interengaging clip 142 comprises a first C-shape component 143 and a second C-shape component 144. The C-shaped components 143, 144 comprise interengagement features 143a, 144a for removably coupling together while providing engagement with a portion of the engagement features 130. Example interengagement features 143a, 144a include male and female snaps, magnets and barb and aperture pairs. In one form, inner portions 145 of the C-shaped components 143, 144 comprise protrusions 143b, 144b. When installed, the protrusions 143b, 144b are inserted into a hole 136 through the body of the drive piece 100, so that the axial position of the stop member 140 remains unchanged when the same is removably coupled thereto. Further, the protrusions 143b, 144b accommodate in constraining the angular position of the stop member 40. Optionally, the inner portions 145 are sized and shaped to engage a portion of the engagement features 130.

In another form, as depicted in FIG. 5B, a cylindrical rod or pin 146, as depicted in FIG. 6H, can be used as the stop member 140. For example, the pin 146 having a body portion 147 extending from a first end 146a and a second end 146b is engaged with a particular axially positioned hole 136 along the longitudinal axis of the shank portion 120. Preferably, the pin is sized to provide releasable engagement with the hole 136 such that the first and second ends 146a, 146b project beyond the outer contour of the shank portion 20. Optionally, other forms of pins may be provided, for example, a pin having an outwardly biased ball for contributing to retaining the pin within the hole 136.

As seen in FIGS. 5C-D, the shank portion 120 defines a plurality of depth stop receiver positions 130 at axially spaced positions along its length. In alternate embodiments, more or fewer receiver positions are provided. For example, FIG. 5C shows a drive piece 100 comprising nine total depth stop receiver positions 130, whereas FIG. 5D shows a drive piece comprising a total of six depth stop receiver positions 130. Various alternative configurations of differing size, quantity and position of depth stop receiver positions 130 can be provided as desired, within the scope of the invention.

FIGS. 7-8F shows a drive piece 200 according to another example embodiment of the present invention. The shank portion 220 comprises a plurality of engagement slots 230 forming stop receiver positions for engaging a stop member 240 with indexing engagement therein, thereby allowing for adjustment to the axial position of the stop member 240 thereon. The shank portion 220 extends from a first end 222 to a second end 224. One or more axially extending slots or channels 232 extend lengthwise along the periphery of the shank portion 220 generally parallel to the longitudinal axis of the shank portion. Two or more circumferential slots or channels 234 arranged in an axially spaced array extend transversely from each axially extending channel 232.

The channels 232, 234 can be formed to provide substantially uniform engagement with the stop member 240 and/or can be shaped as desired to provide removable engagement therewith. For example, as shown in FIGS. 8A-B, one of the entrance channels 232 can be provided with generally uniform positioning channels 234 (see FIG. 8A), and another entrance channel 232 can be provided with positioning channels 234 that are shaped as desired, for example not generally uniform or multi-angular (see FIG. 8B). In one form, at least one of the positioning channels 234 forms a draft-like feature having an included angle of about 20 degrees that extends from a portion of the entrance channel 232 to the end of the positioning channel 234 having a dimension of about 0.013″ (see FIG. 8D). As depicted in FIG. 8F, multiple entrance channels 232 can be arranged at positions around the shank portion 222 circumference, for example four entrance channels arranged at ninety-degrees with respect to each other. The entrance channels 232 can change width, for example in FIG. 8F in which the channels narrow from the exterior surface to the interior. Optionally, depth indicia 260 can be provided along the periphery of the shank portion 220 to provide indication of the axial positions provided by the positioning channels 234.

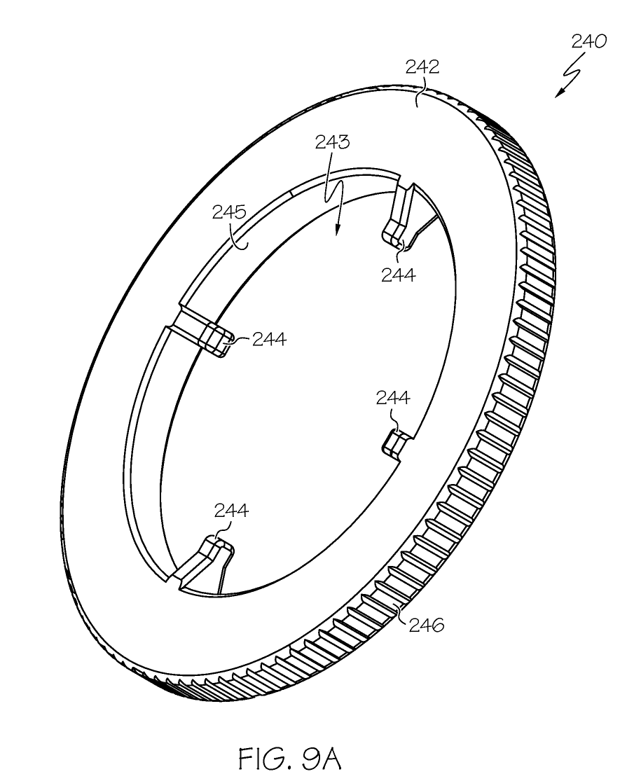

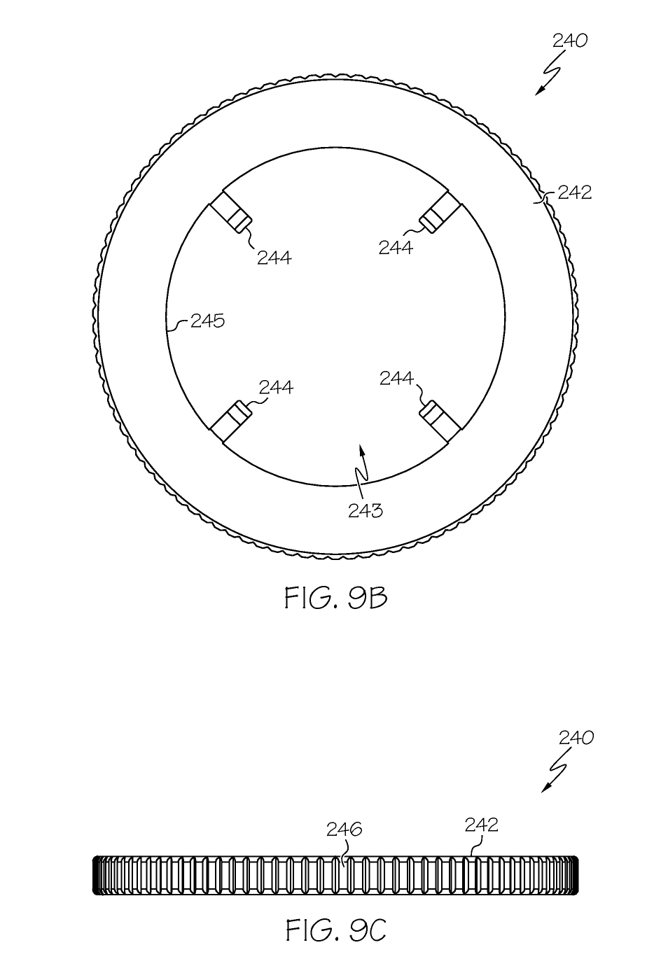

FIGS. 9A-C show the stop member 240 comprising a ring-shaped body 242 having one or more (four are depicted) teeth or projections 244 extending inwardly from an inner annular face 245 into a central opening 243. The projections 244 are configured for engagement within the axially extending entrance channels 232 and the circumferential channels 234 with a free-running or loose interference fit for repositionable placement at a specified depth setting. Ridges or knurling 246 can be formed along the outer periphery of the member 242 to assist the installation and adjustment between axial positions.

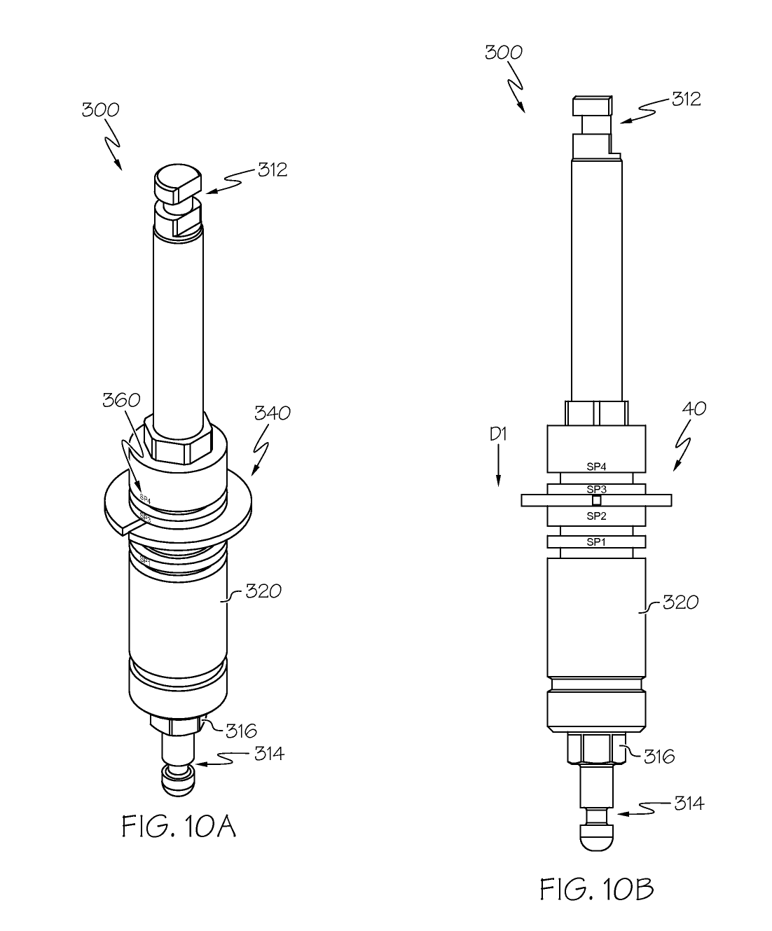

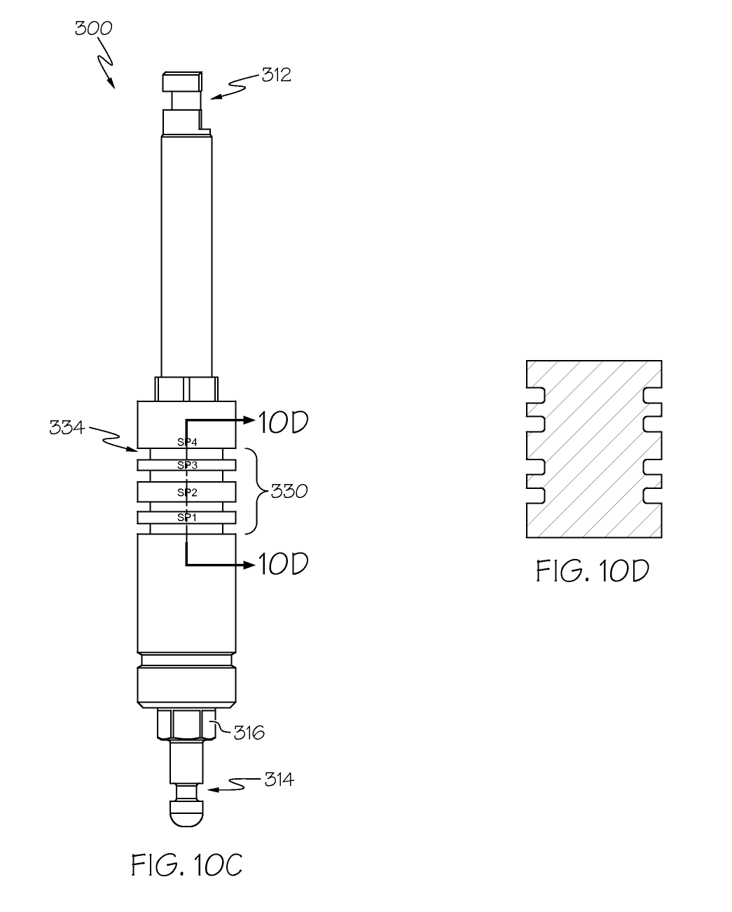

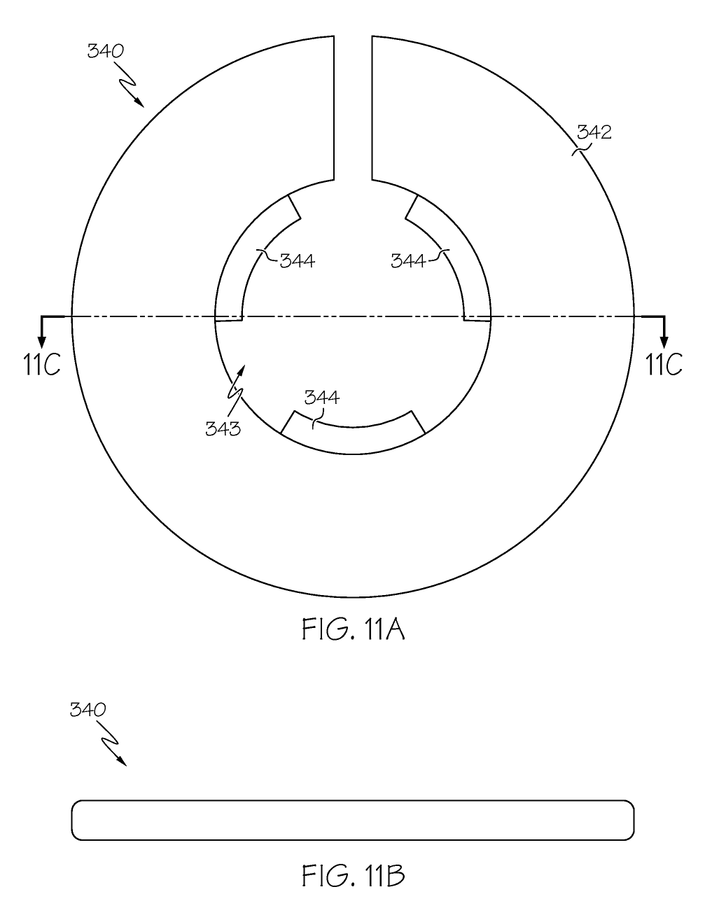

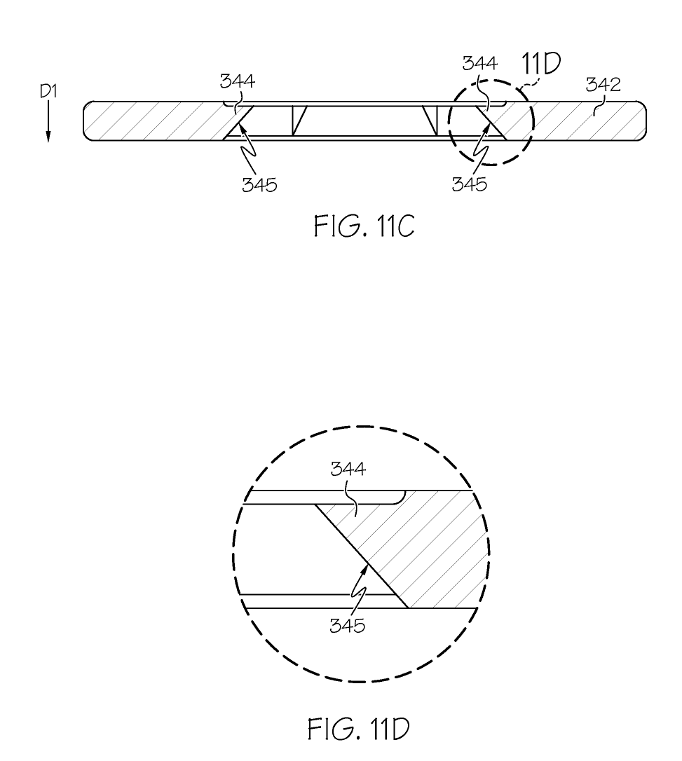

FIGS. 10A-D show a drive piece 300 according to another example embodiment of the present invention. The drive piece comprises a repositionable snap-ring stop member 340 (see FIGS. 11A-D) for placement in one of a plurality of depth stop position receivers 330. The stop member 340 is formed from a substantially C-shaped body 342 and comprises a plurality of projections or arcuate fins 344 extending inwardly towards the center of the snap ring. In example forms, the fins 344 provide for indexing between several axially spaced positions such that movement from one axial position to another axial position is provided by flexing of the stop member 340. For example, the stop member 340 is generally shaped and formed to provide for outward flexing when indexing the same between the engagement features 330. The projections 344 optionally comprise an acutely angled inclined face portion 345 to facilitate repositioning the stop ring in a first axial direction (see arrow D1), and resist movement in the opposite direction.

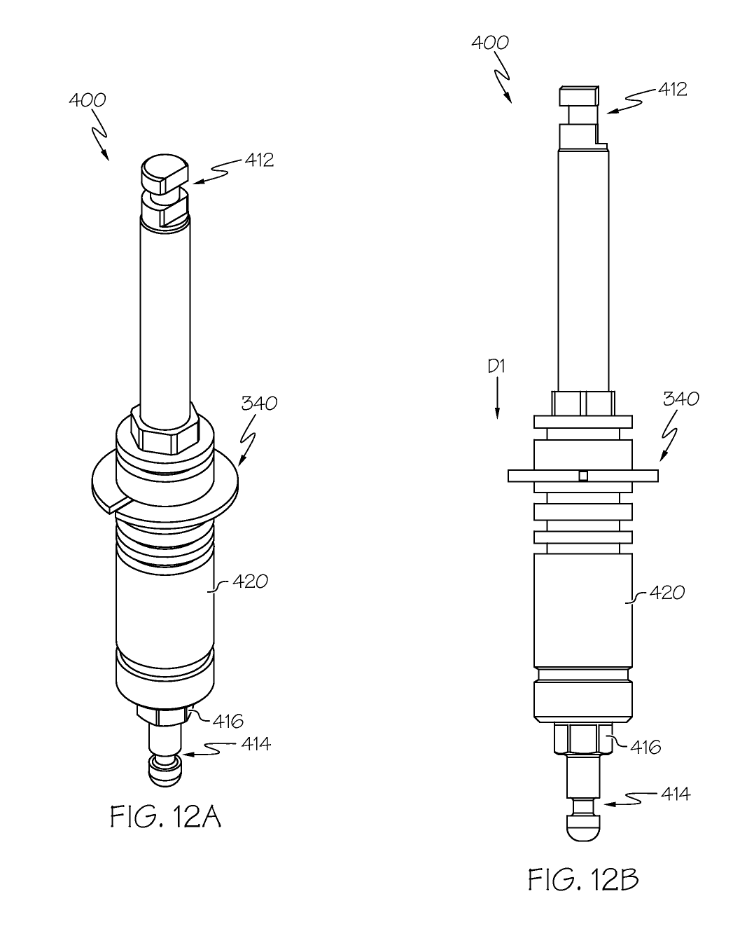

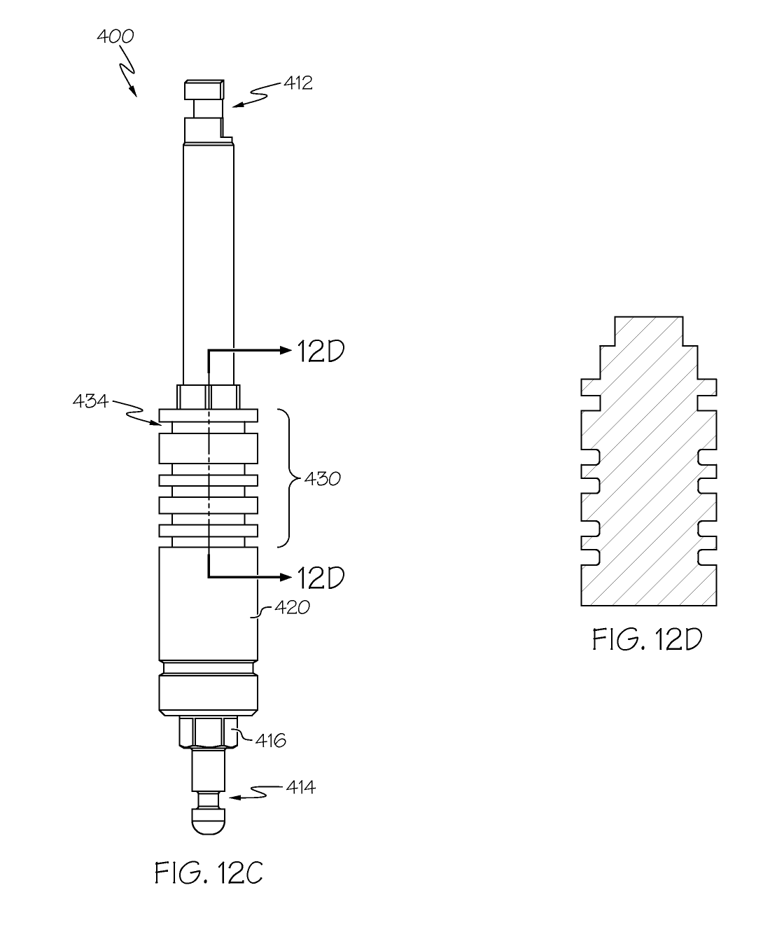

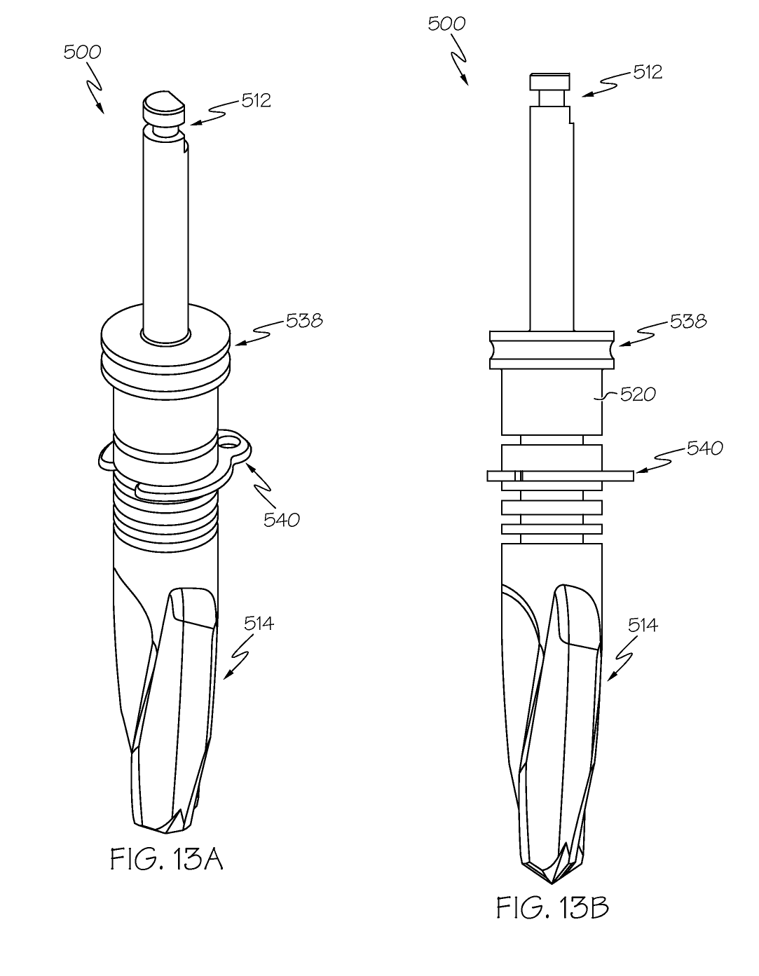

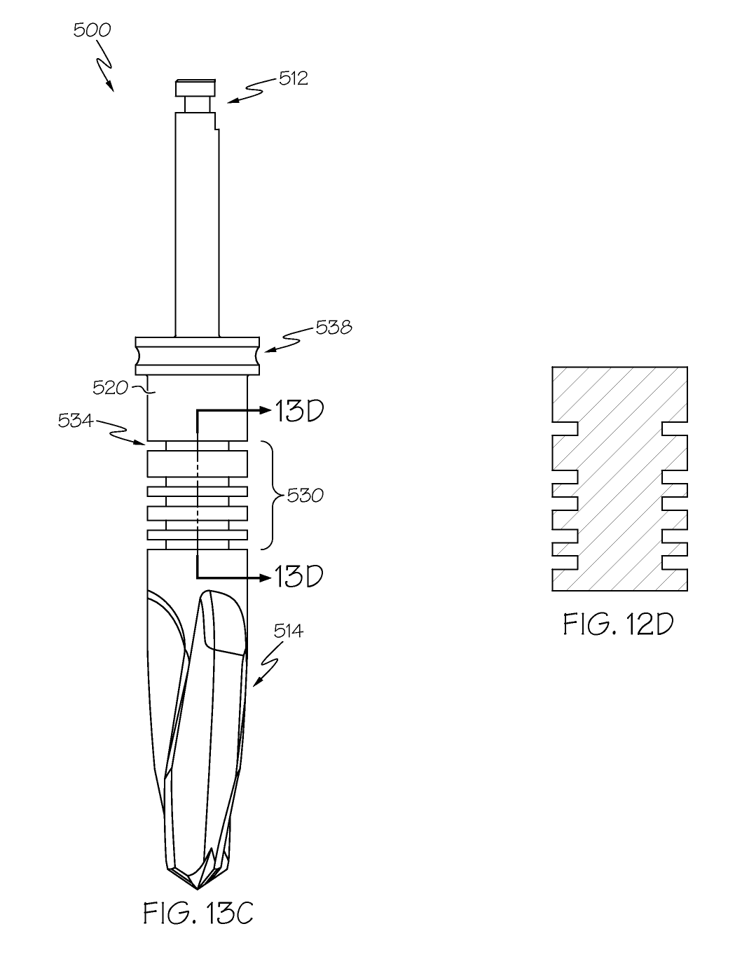

FIGS. 12A-D show a drive piece 400 according to another example embodiment of the present invention. As shown, the drive piece 400 is substantially similar to the drive piece 300 with the exception of the quantity and axial position of the engagement features 430. As depicted, the drive piece comprises five channels 434 extending along the longitudinal axis of the shank portion 420.

FIGS. 13A-D show a drill piece 500 according to another example embodiment of the present invention. In example forms, a stop member 540 (or other desired stop member) is configured to removably engage a drill piece 500 for restricting the depth or extension of the same during drilling. The drill piece 500 comprises a connection end 512 for coupling to a driver, and a working or cutting end 514 that is generally integral with a shank portion 520 therebetween. A plurality of depth setting receivers 534 are provided along a depth setting range 530 of the shank portion 520, for repositionable engagement of the stop member 540 in a selected one of the depth setting receivers. Optionally, a depth stop limit or flange 538 is formed along a portion of the drill piece 500 to act as a final stop, for example, when it is desired that the cutting end 514 allow for full extension of the same during the drilling process, for example when the stop member 540 is entirely removed. In example forms, the flange 538 is generally positioned closest to the first end 512 relative to the channels 534 formed along the shank portion 620. Preferably, the cutting end 514 can be formed as desired, as for example, having a desired size, length, configuration and/or other specifications for performing a surgical procedure.

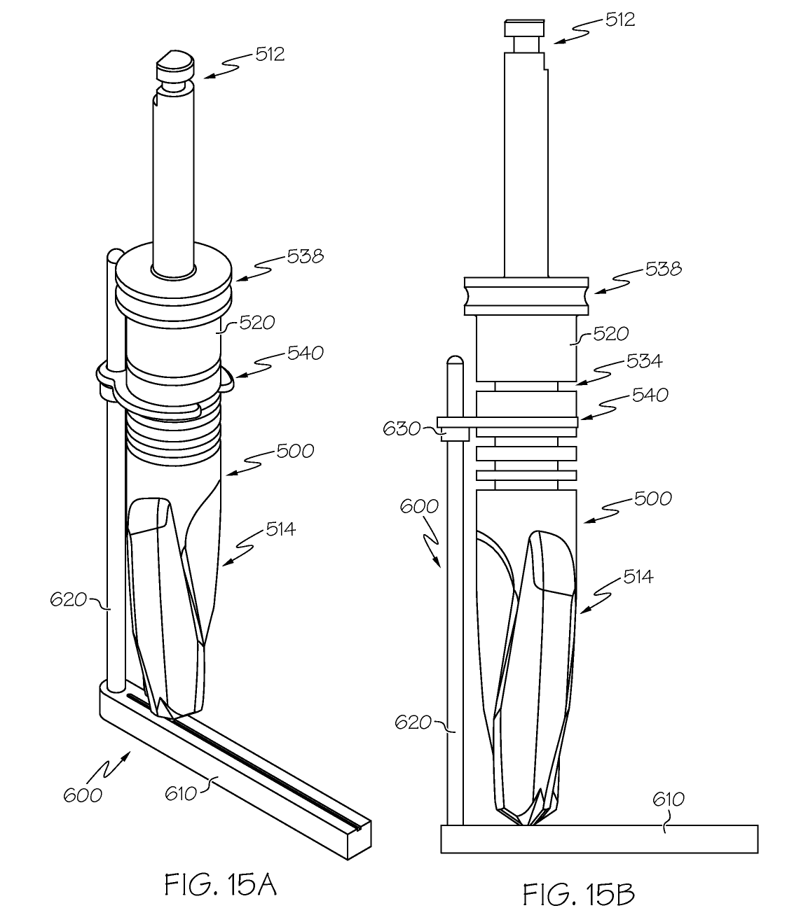

FIGS. 14A-D show an installation guide 600 according to an example embodiment of the present invention, for assisting a practitioner in positioning a stop member at a specified depth setting on a tool or instrument. In example forms, the installation guide 600 is generally L-shaped and comprises a base 610, a guide post 620 extending generally transverse relative to the base 610, and a grommet or stop 630. In one form, the base 610 is generally elongate with a channel 640 that is partially formed therein comprising an alignment indention 645 for receiving a portion of the cutting end 614. The guide post 620 extending from the base preferably provides engagement with the stop 630 to position the same at a desired axial position so that the stop member can contact the stop 630 and align with the specified depth setting channel of the tool or instrument (see FIGS. 15A-B). In example forms, the longitudinal axis of the tool or instrument is retained in a position generally parallel to and laterally offset from the guide post 620, and the guide post extends through a positioning hole in the stop member, which rests upon the stop 630 of the installation guide.

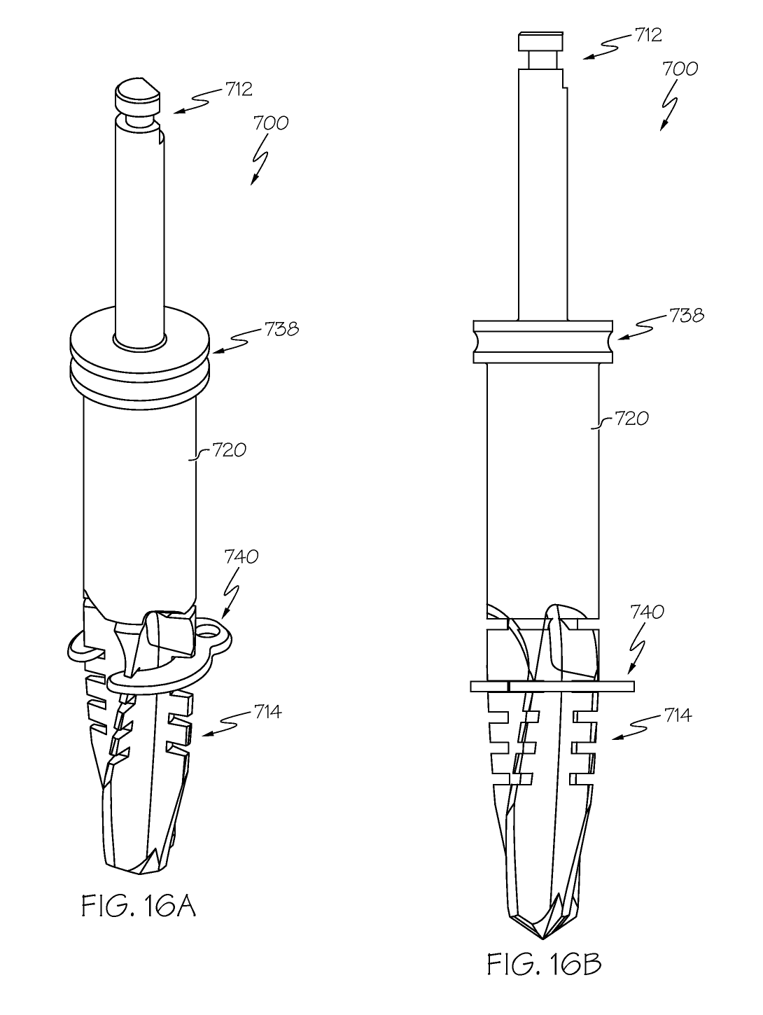

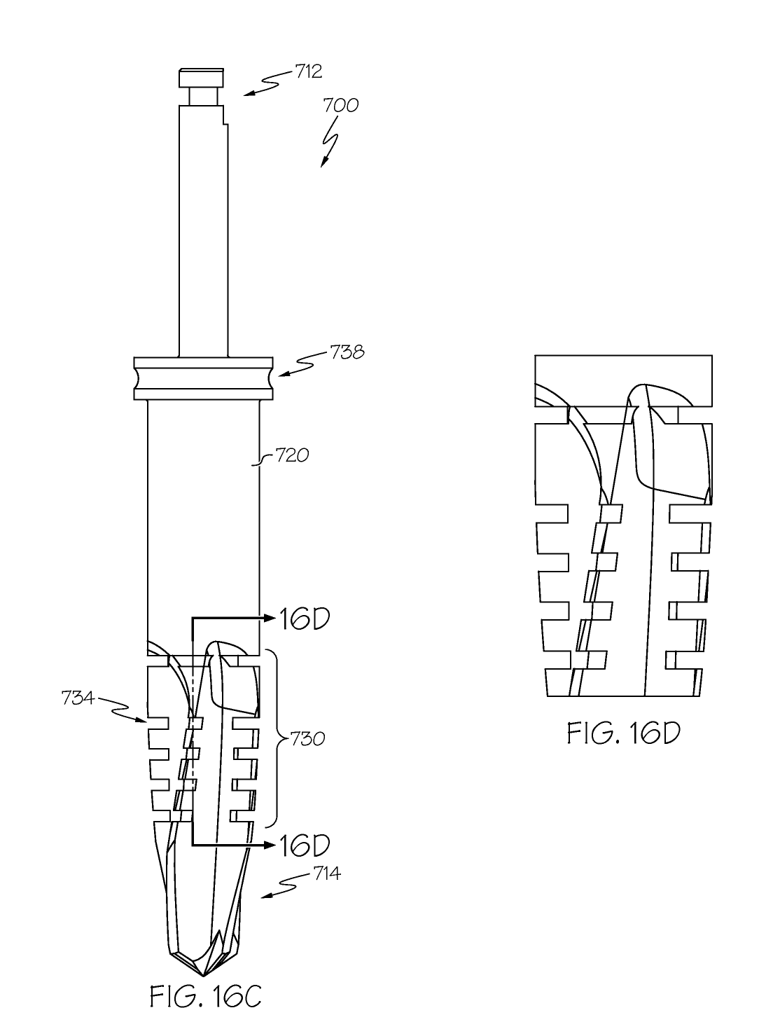

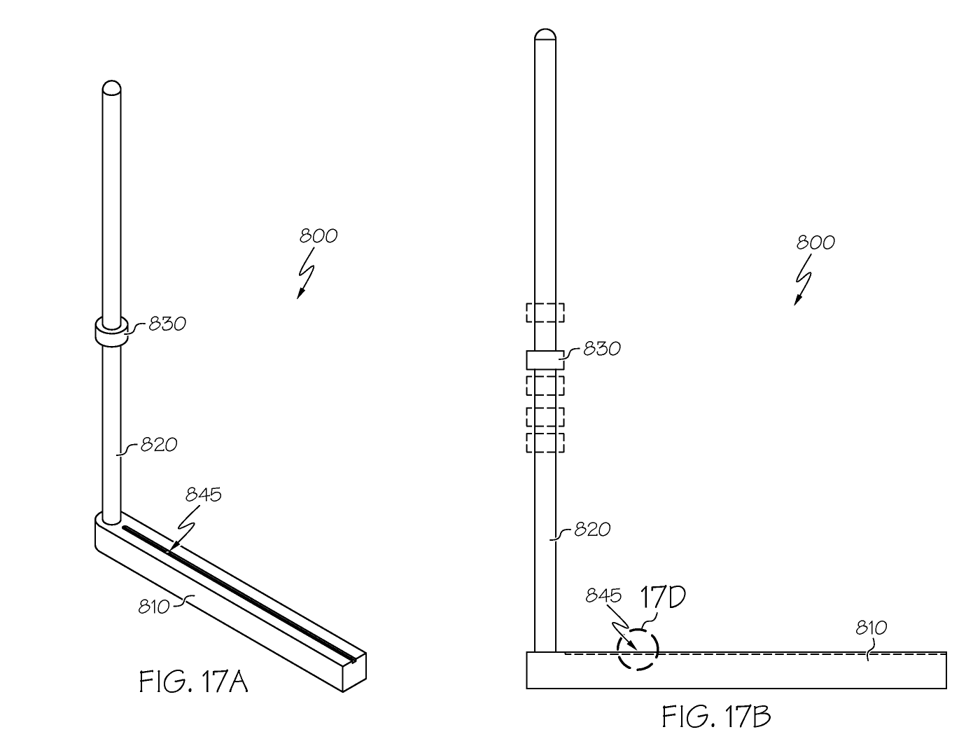

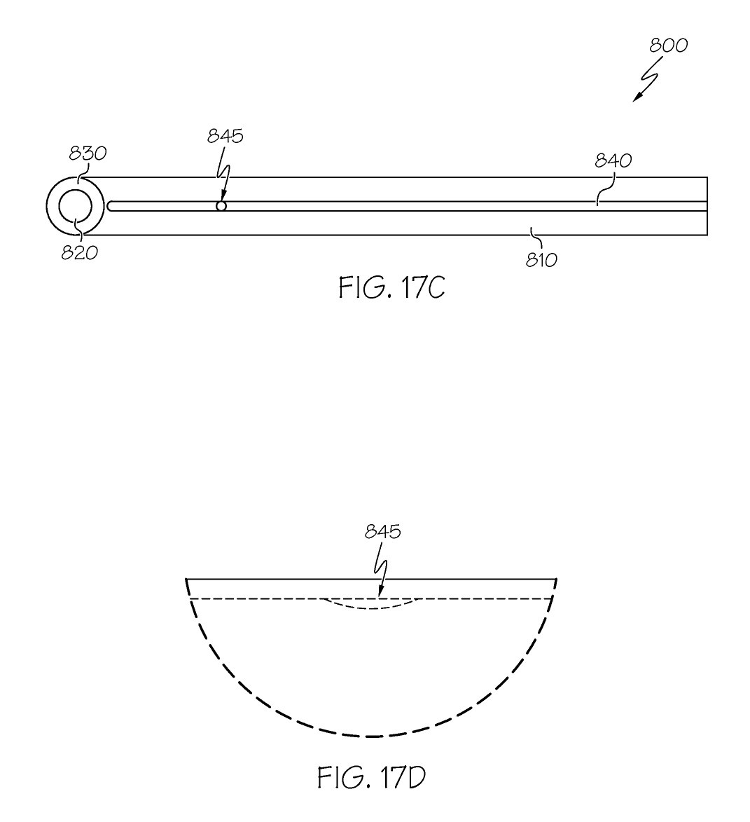

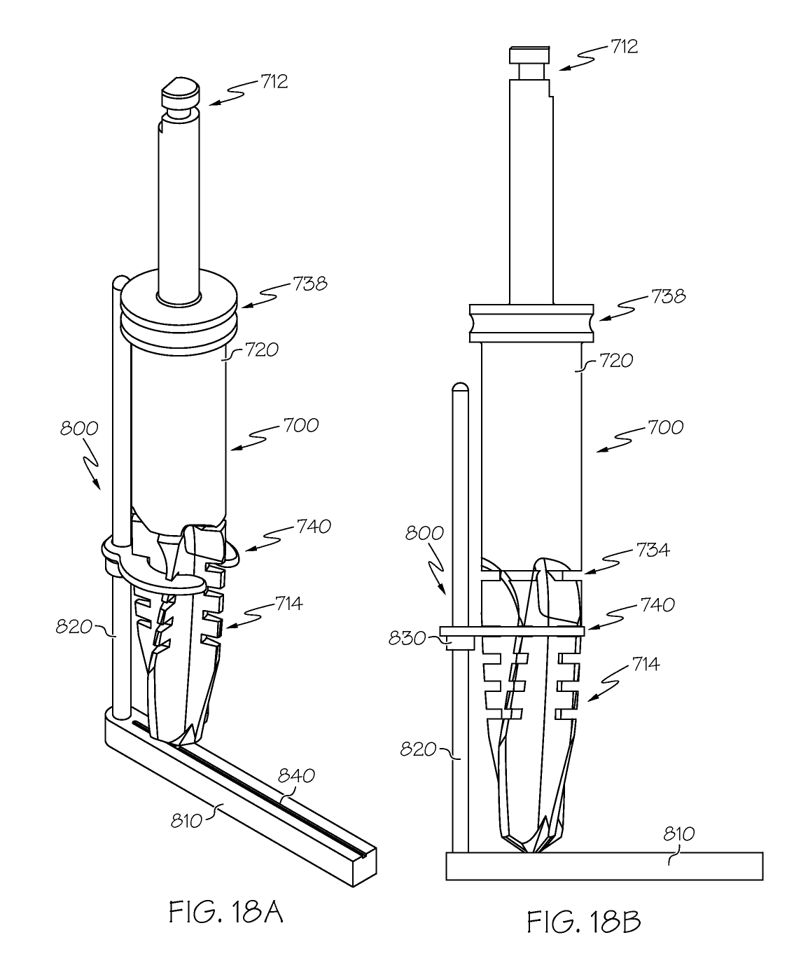

FIGS. 16A-18B show another example embodiment of a drill piece 700 and an installation guide 800. As depicted, the drill piece 700 comprises a plurality of depth setting receivers 734 spaced axially along a depth setting range 730, formed along the working end 714 of the drill piece 700. A stop member 740 is installed into a selected one of the receivers 734 by positioning stop 830 of the installation guide at the specified height, placement of the stop member 740 onto the guide post 820 against the stop 830, and engaging the stop member 740 into the corresponding receiver 734 of the tool 700.

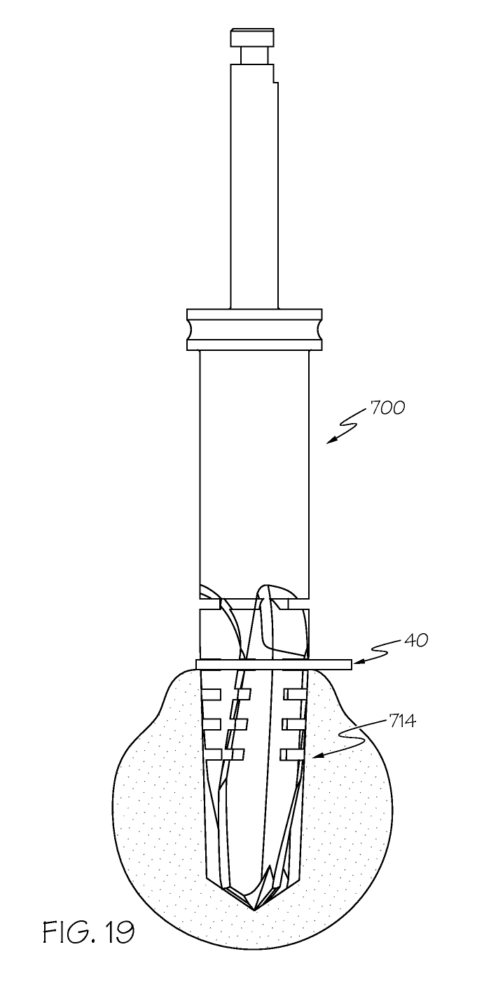

FIG. 19 shows the drill piece 700 subsequent to operation on a bone according to an example method of use according to the present invention. As depicted, the depth of penetration of the drill is limited by contact of the stop member 40 against an anatomical surface (for example bone), or against another stop surface.

The present invention also relates to methods of adjusting a depth stop retained on a surgical instrument. In example forms, the method preferably comprises providing a surgical instrument having a plurality of engagement features provided at predetermined positions along a defined longitudinal axis, and providing a stop member having at least one feature for engagement with the plurality of engagement features provided on the surgical instrument. In example embodiments, the method further includes providing adjustability to the axial positioning of the stop member along the longitudinal axis of the surgical instrument, wherein the stop member may provide for removable coupling between the plurality of engagement features (thus, varying the axial position thereof) or indexing therebetween (thus, maintaining engagement therewith while changing the axial position thereof).

In another example embodiment, the present invention relates to methods of planning a surgical procedure. In example forms, the method preferably comprises providing a scan of a patient's surgical area; viewing the patient's surgical area with computerized software, the computerized software providing information regarding the plurality of instruments that may be used to perform the surgery, the instruments including surgical drills and/or drill pieces; and providing instructions to a practitioner regarding the tools required to perform the surgery and specified depth stop positioning on a tool or instrument for proper implant placement. In example forms, the method of planning a surgery preferably provides a practitioner with a plurality of instructive and patient specific guidelines to ensure the surgery will be as quick, precise and efficient as possible. For example, as described above, the pre-surgical procedure for providing dental implants commonly uses computerized software to obtain and/or view a three-dimensional scan of the patient's surgical area. In example forms, the computerized software is configured to provide the surgeon or administrator with the surgical plan listing the required drill/drivers and the position of the depth stops. For example, according to one form, a computed tomography (CT) scan of the patient's surgical area provides the surgeon and/or administrator with a three-dimensional model of the scan that is viewable within computer software (e.g., software that is installed on a computer). As the computer software preferably provides information regarding the plurality of surgical drills and/or drill pieces 10, 100, 200, and/or 300 (as described above), the surgeon and/or administrator can prompt the computer software to provide plans regarding the patient-specific surgery to be performed.

In example embodiments, the drive piece can be constructed of a plurality of materials, for example, metals, plastics, etc. Preferably, the drive piece is formed of a titanium alloy or other material suitable and safe for surgical procedures. In example forms, the stop member can be constructed of a plurality of materials and/or combinations thereof, for example, metals, plastics, composites, resins, rubbers, or other available materials. Optionally, a plurality of components can couple together and/or form a co-molded stop member to accommodate removable engagement with the depth features of the drive piece. Preferably, portions of the components and/or portions of the co-molded piece can provide flexibility to the stop member to accommodate removable coupling and/or indexing between the plurality of axial positions of the depth features formed along the periphery of the shank portion.

While the invention has been described with reference to preferred and example embodiments, it will be understood by those skilled in the art that a variety of modifications, additions and deletions are within the scope of the invention, as defined by the following claims.

What is claimed is:

1. A surgical instrument system for depth stop adjustment, the instrument comprising:
a generally elongate body portion defining a longitudinal axis extending from an engagement end to a working end;
a plurality of axially spaced grooves extending along the periphery of the elongate body, each axially spaced groove comprising a pair of receivers; and
a stop member comprising a pair of separably coupled components that removably engage the plurality of axially spaced grooves, each separably coupled component comprising a protrusion that is removably received by the receivers.

2. The system of claim 1, wherein the pair of receivers comprise apertures extending into the elongate body.

3. The instrument of claim 1, wherein the axially spaced grooves comprise a circumferential shape.

4. The instrument of claim 1, wherein the separably coupled components comprise an outer edge and an inner edge.

5. The instrument of claim 4, wherein the separably coupled component inner edges form a circumferential edge when coupled together.

6. The instrument of claim 1, wherein the separably coupled components comprise interengagement features for removably coupling the pair of separably coupled components together.

7. A surgical instrument system for depth stop adjustment, the instrument comprising:
a generally elongate body portion defining a longitudinal axis extending from an engagement end to a working end;
at least one axially extending channel extending along the generally elongate body generally parallel to the longitudinal axis;
a plurality of axially spaced grooves extending transversely and unidirectionally from the at least one axially extending channel; and
a stop member comprising at least one projection that removably engages the at least one axially extending channel and the plurality of axially spaced grooves.

8. The system of claim 7, wherein the system comprises four of the axially extending channels arranged at ninety-degrees with respect to each other.

9. The system of claim 8, wherein the stop member comprises four of the projections arranged at ninety-degrees with respect to each other.

10. The system of claim 7, wherein the stop member comprises an annular body, the at least one projection projecting inwardly from the annular body.

11. The system of claim 10, wherein the stop member comprises a grip surface extending around the annular body.

12. A method of adjusting a depth stop retained on a surgical instrument comprising a generally longitudinal axis, the method comprising:
providing a surgical instrument having a plurality of axially spaced grooves provided at predetermined positions with respect to the longitudinal axis;
providing a stop member having at least one feature for engagement with the plurality of axially spaced grooves provided on the surgical instrument; and
removably engaging the stop member with at least one of the plurality of axially spaced grooves.

13. The method of claim 12, wherein each axially spaced groove comprises a pair of receivers; and the stop member comprises a pair of separably coupled components that removably engage the plurality of axially spaced grooves, each separably coupled component comprising a protrusion that is removably received by the receivers.

14. The method of claim 13, further comprising engaging the pair of separably coupled components with at least one of the plurality of axially spaced grooves, and removably coupling the pair of separably coupled components together.

15. The method of claim 14, further comprising decoupling the pair of separably coupled components, disengaging the stop member from the at least one of the plurality of axially spaced grooves, engaging the stop member with a different at least one of the plurality of axially spaced grooves, and removably coupling the pair of separably coupled components together.

16. The method of claim 12, further comprising at least one axially extending channel extending generally parallel to the longitudinal axis, wherein the plurality of axially spaced grooves extending transversely and unidirectionally from the at least one axially extending channel.

17. The method of claim 16, wherein the stop member feature for engagement comprises a projection that removably engages the at least one axially extending channel and the plurality of axially spaced grooves.

18. The method of claim 17, further comprising repositioning the stop member protrusion from one axially spaced groove to a different axially spaced groove by moving the stop member protrusion along the axially extending channel.

19. A guide for installing a stop member on a working tool, the working tool comprising a plurality of depth stop locations extending along a defined longitudinal axis, the stop member comprising a feature for engagement with the guide, the guide comprising:
a base;
a guide post, the guide post having a first and second end generally opposite thereto, the first end engaging the base and the second end extending generally transverse relative to the base; and
a stop ring engaged with the guide post to provide for the desired axial positioning of the stop member when the feature is engaged with the guide post.

20. The guide of claim 19, wherein the base further comprises a channel having an indentation for receiving a portion of the working end of the working tool to provide alignment of the desired depth stop location with the stop member having the feature engaged with the guide post.

21. A drill system comprising:
a generally elongate body portion defining a longitudinal axis extending from an engagement end to a working end;
a plurality of depth stops comprising grooves that are axially separated along the elongate body longitudinal axis; and
a stop member removably received within one of the grooves.

22. The drill of claim 21, wherein the stop member has a generally annular shape.

23. The drill of claim 22, wherein the stop member provides adjustability to the position that the second end is permitted to work against or extend through a bone, surface or feature to allow for the proper depth of the working tool extending therein.

24. The drill of claim 23, wherein the bone, surface or other feature provide an engagement surface for contacting the stop member engaged with the at least one depth stop location of the drill piece.

25. The drill of claim 23, wherein the stop member can be repositioned between axial positions along the longitudinal axis.

26. The drill of claim 25, wherein repositioning the stop member to another axial position requires that the stop member disengage the drill.

27. The drill of claim 25, wherein the repositioning of the stop member allows for maintaining engagement therewith such that the same can index between the depth stop locations.
